(19) United States
(12) Patent Application Publication
(10) Pub. No.: US 2008/0159787 A1
(43) Pub. Date: Jul. 3, 2008

(54) ELECTROPHOTOGRAPHIC IMAGE FORMING APPARATUS HAVING TRANSPARENT TONER AND METHOD THEREOF

(75) Inventors: Jong-woo LEE, Suwon-si (KR); Ki-Jae Do, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/766,983

(22) Filed: Jun. 22, 2007

(30) Foreign Application Priority Data
Dec. 28, 2006 (KR) 2006-136806

(51) Int. Cl. G03G 15/01; G03G 15/16

(52) U.S. Cl. 399/223; 399/299; 399/298; 399/296

(57) ABSTRACT

An electrophotographic image forming apparatus and method thereof. The apparatus includes a photosensitive body, an exposing unit to form an electrostatic latent image on the photosensitive body charged to a uniform electric potential, and a developing unit to develop the electrostatic latent image on the photosensitive body, wherein a color toner attached to an image portion of the electrostatic latent image and a transparent toner charged to an opposite polarity to the polarity of the color toner and attached to a non-image portion of the electrostatic latent image are together accommodated in the developing unit, and at least one of the color toner and the transparent toner is a potato type polymerization toner.

### CROSS-REFERENCE TO RELATED APPLICATIONS

This application claims priority under 35 U.S.C. §119(a) from Korean Patent Application No.10-2006-0136806, filed on Dec. 28, 2006, in the Korean Intellectual Property Office, the disclosure of which incorporated herein in its entirety by reference.

### BACKGROUND OF THE INVENTION

1. Field of the Invention

The present general inventive concept relates to an electrophotographic image forming apparatus and method thereof, and more particularly, to an electrophotographic image forming apparatus having a transparent toner, and method thereof.

2. Description of the Related Art

Conventional electrophotographic image forming apparatuses form an electrostatic latent image by scanning light onto a photosensitive body charged to a uniform electric potential, develop the electrostatic latent image with a predetermined color of toner and then transfer and fuse the developed image to and on a printing medium, thereby printing a desired image. In general, four colors of toners, such as yellow (Y), magenta (M), cyan (C), and black (B), are used in electrophotographic color image forming apparatuses, and four developing units are used to develop the electrostatic latent image formed on the photosensitive body with these four colors of toners.

A toner is manufactured based on a plastic resin, and thus has some gloss. A portion of a printed image to which the toner is attached has some gloss, but a background region of the printed image to which the toner is not attached has no gloss. In addition, the higher coverage (the ratio of an area to which the toner is attached to the area of the printing medium) of the printed image, the higher the gloss. The gloss of the printed image affects the visual quality of the image. U.S. Patent Application No. 20060127134 discloses an image forming apparatus featuring a transparent image forming station to improve the gloss of a printed image by employing developing devices for developing electrostatic images with color toners and a developing device for developing an electrostatic image with a transparent toner.

### SUMMARY OF THE INVENTION

The present general inventive concept provides an electrophotographic image forming apparatus which develops a transparent toner image using a developing unit corresponding to a color toner.

The present general inventive concept also provides an electrophotographic image forming apparatus in which color toners and a transparent toner can be easily separated from each other.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an electrophotographic image forming apparatus, including a photosensitive body, an exposing unit to form an electrostatic latent image on the photosensitive body charged to a uniform electric potential, and a developing unit to develop the electrostatic latent image on the photosensitive body, wherein a color toner attached to an image portion of the electrostatic latent image and a transparent toner charged to an opposite polarity to the polarity of the color toner and attached to a non-image portion of the electrostatic latent image are together accommodated in the developing unit, and at least one of the color toner and the transparent toner is a potato type polymerization toner.

The apparatus may further include a pre-transfer charging unit to charge the color toner and the transparent toner developed on the photosensitive body to the same polarity.

The apparatus may further include a plurality of second photosensitive bodies, a plurality of second exposing units to form electrostatic latent images on the plurality of the second photosensitive bodies, and a plurality of developing units which develop electrostatic latent images on the plurality of the second photosensitive bodies and in which different color toners from the color toner are respectively accommodated, wherein color images are formed using a single pass technique.

The exposing unit may be a tri-level exposing unit having a three-level exposure output such as a high output, a low output, and no output.

The apparatus may further include a plurality of second developing units in which different color toners from the color toner are respectively accommodated, and a transfer medium to which a transparent toner image and a plurality of color toner images sequentially developed on the photosensitive body are sequentially transferred, wherein color images are formed using a multiple pass technique.

The exposing unit may be a tri-level exposing unit having a three-level exposure output such as a high output, a low output, and no output.

The foregoing and/or other aspects and utilities of the present general inventive concept may also be achieved by providing an electrophotographic image forming apparatus, including a photosensitive body, an exposing unit to form an electrostatic latent image on the photosensitive body, and a developing unit to uniformly distribute a charge on a surface of a color toner with a first polarity and to uniformly distribute a charge on a surface of a transparent toner with a second polarity opposite to that of the first polarity in order to develop the electrostatic latent image on the photosensitive body.

The color toner may be charged to be attached to an image portion of the electrostatic latent image and the transparent toner may be charged to be attached to a non-image portion of the electrostatic latent image.

The at least one of the color toner and the transparent toner may be a potato type toner manufactured by polymerization.

The electrophotographic image forming apparatus may further include an intermediate transfer belt to which images corresponding to the color toner and the transparent toner are temporarily transferred.

The foregoing and/or other aspects and utilities of the present general inventive concept may also be achieved by providing a single pass image forming apparatus, the apparatus including a plurality of photosensitive bodies to develop images thereon using a color toner with a polarized charge and a transparent toner with another polarized charge opposite to the polarized charge of the color toner, and a plurality of transfer units corresponding to the photosensitive bodies to transfer a transparent toner image and a color toner image to a printing medium, wherein at least one of the color toner and the transparent toner includes a surface with a uniformly distributed charge.

The at least one of the color toner and the transparent toner may be a potato type toner manufactured by polymerization.

Different colors corresponding to the color toner image and the transparent toner image may be transferred directly to the printing medium when the printing medium passes through an area between each of the plurality of photosensitive bodies and the plurality of transfer units.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates the structure of a single pass color image forming apparatus which is a type of an electrophotographic image forming apparatus according to an embodiment of the present general inventive concept;

FIGS. 2A and 2B illustrate an adhesive force to an uncharged substrate of each of an irregular shaped toner and a potato type toner;

FIG. 2C illustrates an adhesive force between irregular shaped toners;

FIG. 2D illustrates an adhesive force between potato toners;

FIG. 2E illustrates an adhesive force between a potato toner and an irregular shaped toner;

FIG. 3 illustrates an electric potential of the surface of an exposed photosensitive drum;

FIG. 4 illustrates a portion in which a photosensitive drum and a developing roller contacts each other in detail;

FIG. 5 illustrates a pre-transfer charging unit;

FIG. 6 illustrates an example of a control circuit to perform tri-level exposure;

FIG. 7 illustrates an operation of developing a transparent toner using tri-level exposure;

FIG. 8 illustrates a structure of a single pass color image forming apparatus employing a direct transfer technique, which is a type of an electrophotographic image forming apparatus, according to another embodiment of the present general inventive concept; and

FIG. 9 illustrates a structure of a multiple pass color image forming apparatus, which is a type of an electrophotographic image forming apparatus according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

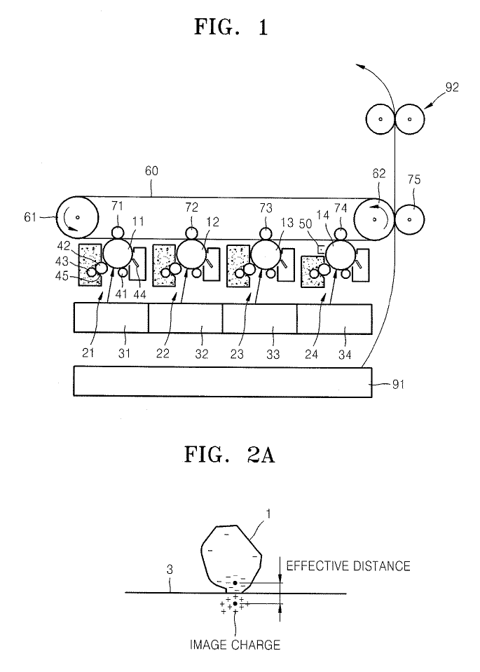

FIG. 1 illustrates a structure of an electrophotographic image forming apparatus according to an embodiment of the present general inventive concept. Referring to FIG. 1, the electrophotographic image forming apparatus according to the present embodiment is a single pass color image forming apparatus which includes four photosensitive drums (a.k.a., photosensitive bodies) 11, 12, 13, and 14, four exposing units 31, 32, 33, and 34, and four developing units 21, 22, 23, and 24 which are used to perform a color printing operation.

Color toners such as black (B), magenta (M), cyan (C), and yellow (Y) are accommodated in the four developing units 21, 22, 23, and 24, respectively.

Each of the four photosensitive drums 11, 12,13, and 14 is an example of a photosensitive body on which an electrostatic latent image is to be formed, for example, an organic photosensitive body or an Amorphous silicon photosensitive body having a long life span. Each of the four photosensitive drums 11, 12,13, and 14 corresponds to each of the developing units 21, 22, 23, and 24.

Each of a plurality of charging rollers 41 is an example of a charging unit to charge each of the photosensitive drums 11, 12,13, and 14 to a uniform electric potential. Each of the charging rollers 41 are in contact with one of the photosensitive drums 11, 12,13, and 14, respectively. A charging bias voltage is applied to each of the charging rollers 41, and each of the charging rollers 41 charges the surfaces of the photosensitive drums 11,12, 13, and 14, respectively, to a uniform electric potential.

Each of the four exposing units 31, 32, 33, and 34 scans light modulated according to image information about black (B), magenta (M), cyan (C), and yellow (Y) colors, respectively, onto the photosensitive drums 11, 12,13, and 14 and thereby forms electrostatic latent images. A laser scanning unit (LSU) that uses a laser diode as a light source, is usually used as each of the exposing units 31, 32, 33, and 34.

Each of the four developing units 21, 22, 23, and 24 includes a developing roller 42 and a supply roller 43. The supply roller 43 attaches the toner accommodated in each of the developing units 21, 22, 23, and 24 to the developing roller 42. The developing units 21, 22, 23, and 24 may further include a regulating unit 45 to regulate an amount of the toner attached to the surface of the developing roller 42 to form a layer of toner having a uniform thickness. For example, the regulating unit 45 may be an elastic plate or roller which is elastically in contact with the developing roller 42. In addition, the developing units 21, 22, 23, and 24 may further include at least one carrying unit (not illustrated) to carry the toner accommodated in each of the developing units 21, 22, 23, and 24 into a region in which the developing roller 42 and the supply roller 43 face each other. When a contact developing technique is used, the developing rollers 42 are in contact with the photosensitive drums 11, 12, 13, and 14. A developing bias voltage, which is used to supply the toners accommodated in the developing units 21, 22, 23, and 24 to electrostatic latent images of the photosensitive drums 11, 12, 13, and 14, is applied to each of the developing rollers 42. Due to the developing bias voltage, an electric potential difference between the developing rollers 42 and the electrostatic latent images is produced so that the toners are detached from the surface of the developing rollers 42 and are attached to the electrostatic latent images, and the electrostatic latent images are developed with the toners. When a non-contact developing technique is used, each of the developing rollers 42 is positioned to maintain a developing gap between each of the photosensitive drums 11, 12, 13, and 14, and for example, a bias voltage in which an AC current and a DC current are mixed may be used as a developing bias voltage. Use of the contact developing technique will now be described.

An intermediate transfer belt 60 is an example of an intermediate transfer medium to which toner images developed on the photosensitive drums 11, 12, 13, and 14 are temporarily transferred. The intermediate transfer belt 60 faces the photosensitive drums 11, 12, 13, and 14, is supported by support rollers 61 and 62 and travels circulatively. Each of a plurality of first transfer rollers 71, 72, 73, and 74 faces each of the photosensitive drums 11, 12, 13, and 14 when the intermediate transfer belt 60 is placed therebetween. A first transfer bias voltage, which is used to attach the toner images developed on the photosensitive drums 11, 12, 13, and 14 to the intermediate transfer belt 60, is applied to each of the first transfer rollers 71, 72, 73, and 74. For example, a conductive metal roller or a rubber roller in which a semi-conductive rubber having elasticity is put on a metal shaft may be used as each of the first transfer rollers 71, 72, 73, and 74.

A cleaning blade 44 is an example of a cleaning unit to eliminate the toner remaining on the surface of each of the photosensitive drums 11, 12, 13, and 14 after an intermediate transfer operation.

A second transfer roller 75 is positioned to face the intermediate transfer belt 60. A printing medium stacked on a paper feeding cassette 91 is carried by a carrying unit (not illustrated) between the second transfer roller 75 and the intermediate transfer belt 60. A second transfer bias voltage, which is used to transfer the toner images attached to the intermediate transfer belt 60 to the printing medium, is applied to the second transfer roller 75. A fusing unit 92 fuses the toner images on the printing medium by applying heat and pressure to the printing medium.

The image forming apparatus according to an embodiment of the present general inventive concept is characterized in that a transparent (T) toner, as well as color toners of black (B), magenta (M), cyan (C), and yellow (Y), is further used and a transparent toner image is developed using a photosensitive body, an exposing unit, and a developing unit to develop color toners without employing an additional photosensitive body, an additional exposing unit, and an additional developing unit to develop the transparent toner image.

The transparent toner is accommodated in one of the developing units 21, 22, 23, and 24 together with color toners. In addition, the transparent toner has a characteristic that it is charged to an opposite polarity to a polarity of the color toners. Accordingly, when a nonmagnetic mono-component toner is used, the color toners are charged to a negative (−) polarity and the transparent toners are charged to a positive (+) polarity. A colorant which causes a change in color of a binder resin, internal additives such as charge control agent (CCA), wax or the like, and external additives such as silica and titanium oxide (TiO₂) are added to the color toners. Charging amounts of the color toners range from −10 to −25 μC/g measured in suction type Faraday Gauge, and a layer of toner on a developing roller 42 ranges from 0.5 to 1 mg/cm². A composition of the transparent toner is almost the same as a composition of the color toners, except for the colorant, the charge control agent (CCA) to adjust a charging polarity, and part of the external additives.

Quality of a printed image depends on the surface roughness or thickness of the printed image in addition to resolution, a gray-scale property, graininess, and color reproducibility. Color images printed by electrophotography have a difference of several times in thicknesses of images (the thicknesses of various layers of toner on the printing medium) according to colors. In order to reduce the thickness of an image, gloss of the printed image needs to be made uniform by reducing the overall thickness of the image. Using a toner having a small size is effective to reduce noise of the image and to reduce the thickness of the image. In addition, the color toners and the transparent toner charged to different polarities in the same developing unit tend to be attached to one another, and the adhesive force between the color toners and the transparent toners must be minimized.

There are limitations in manufacturing a toner having a small size by using a crushing method by which a toner having a small size is manufactured by mixing a base resin, a pigment, a wax, a charge control agent (CCA) or the like in a powder state, by melting, and roll mixing milling them and then by rapidly cooling them to be solidified, and the solidified toner lump is classified according to grades after a crushing operation such as rough crushing, medium crushing, and fine crushing. A polymerization method by which a monomer of a base resin (which is a polymer) is polymerized may result in manufacturing a toner having a small size. In addition, a toner manufactured by the crushing method is an irregular shaped toner and a toner manufactured by the polymerization method is a potato type toner having a nearly spherical shape.

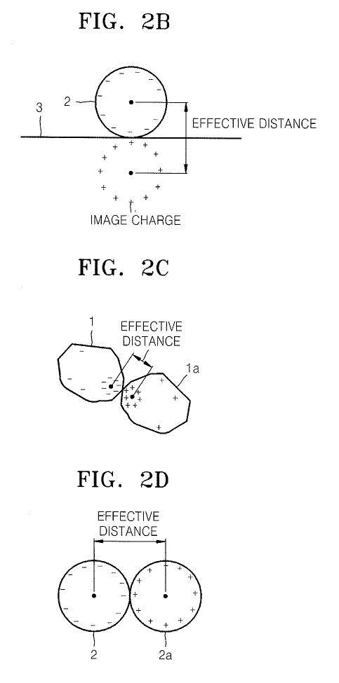

Referring to FIG. 2A, when an irregular shaped toner 1 charged to a negative (−) polarity faces an uncharged substrate 3, an image charge having an identical charging amount as that of the charge of the irregular shaped toner 1 and an opposite polarity to that thereof is induced to the substrate 3. An image force is in inverse proportion to an effective distance between the irregular shaped toner 1 and the image charge. Charges may not be uniformly distributed to a surface of the irregular shaped toner 1 and may be easily concentrated on a portion thereof. Accordingly, a portion on which a largest charging amount is concentrated is attached to the substrate 3. Thus, the effective distance between the irregular shaped toner 1 and the image charge is reduced and a large image force is generated. However, when the potato type toner 2 has an identical effective radius as that of the irregular shaped toner 1, as illustrated in FIG. 2B, since charges are uniformly distributed on the surface of the potato type toner 2, a distance between the potato type toner 1 and the image charge is larger than the distance between the irregular shaped toner 1 and the image charge. Thus, the image force is reduced. In addition, an effective distance between toners 1 and la when irregular shaped toners 1 and la charged to different polarities are attached to each other, as illustrated in FIG. 2C, is smaller than an effective distance between two toners 2 and 2a when potato type toners 2 and 2a charged to different polarities are attached to each other, as illustrated in FIG. 2D, and is also smaller than an effective distance between two toners 1 and 2a when the irregular shaped toner 1 and the potato type toner 2a charged to different polarities are attached to each other, as illustrated in FIG. 2E. Thus, an adhesive force between the irregular shaped toners 1 and la is larger than an adhesive force between the irregular shaped toners 1 and the potato type toner 2a and an adhesive force between the potato type toners 2 and 2a.

An embodiment of the present general inventive concept is characterized in that at least one of the color toners and the transparent toner accommodated in one developing unit is a potato type polymerization toner. By using the potato type polymerization toner, the size of the toner can be reduced, the thickness of an image can be reduced and the gloss of a printed image can be made uniform. In addition, since the adhesive force between the color toners and the transparent toner is small, the transparent toner and the color toners can be easily separated from one another and developed on a photosensitive body. In particular, when a two-component developing agent in which a carrier and a toner are mixed, a description using the above-described image force is effective in describing the adhesive force between the carrier and the toner. As such, the adhesive force between the carrier and the toner can be reduced by using the potato type toner and the toner can be easily separated from the carrier and developed on the photosensitive body.

Accommodation of the transparent toner in the developing unit 24 together with the yellow (Y) color toner will now be described. At least one of the yellow toner and the transparent toner is a potato type toner manufactured by polymerization.

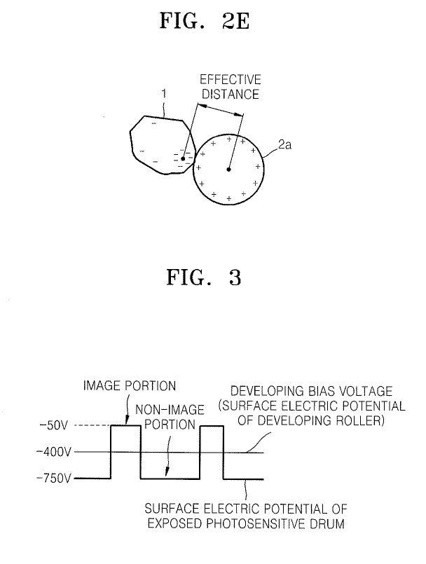

According to the image information about the black (B) color, the second exposing unit 31 scans light onto the photosensitive drum 11 charged by the charging roller 41 to a uniform electric potential and thereby forms an electrostatic latent image. For example, the surface electric potential of the photosensitive drum 11 charged by the charging roller 41 is approximately −750V, as illustrated in FIG. 3. The electric potential of an image portion in which light is scanned by the exposing unit 31 is approximately −50 V. A non-image portion in which light is not scanned by the exposing unit 31 is maintained to the electric potential of the surface of the charged photosensitive drum 11. The average electric potential of the developing bias voltage to be applied to each developing roller 42 of the developing unit 21 is between the electric potential of the image portion and the electric potential of the non-image portion. In the present embodiment, a developing bias voltage having the average electric potential of approximately −400 V is applied to the developing roller 42. Since the black toner is charged to a negative (−) polarity, when the developing bias voltage is applied to the developing roller 42, the black toner accommodated in the developing unit 21 is attached to the image portion. A first transfer bias voltage having an opposite polarity to the charging polarity of the black toner is applied to the first transfer roller 71. As such, the black toner image developed on the photosensitive drum 11 is transferred to the intermediate transfer belt 60.

The same operation as described above is performed by the photosensitive drums 12, 13, and 14, the exposing units 32, 33, and 34, and the developing units 22, 23, and 24, respectively, at time intervals each of which is given by the formula (distance between photosensitive drums)/(carrying speed of intermediate transfer belt), so as to meet color registration requirements.

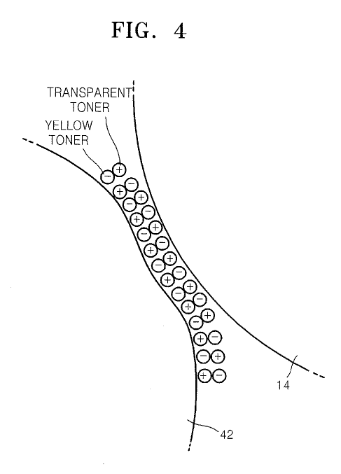

An operation of developing a transparent toner image will now be described. The electric potentials of the image portion and the non-image portion of the photosensitive drum 14 exposed by the exposing unit 34 are identical with those illustrated in FIG. 3. A layer of toner including a yellow toner and a transparent toner is formed on the surface of the developing roller 42 of the developing unit 24, as illustrated in FIG. 4. In order to supply a sufficient amount of the yellow toner and the transparent toner to a developing region in which the developing roller 42 and the photosensitive drum 14 face each other, the thickness of the toner layer formed on the surface of the developing roller 42 may be larger than the toner layer of the developing roller 42 of other developing units 21, 22, and 23. Accordingly, pressure to be applied to the developing roller 42 by the regulating unit 45 may be smaller than pressure applied by the regulating unit 45 of other developing units 21, 22, and 23. When the developing bias voltage is applied to the developing roller 42, the yellow toner and the transparent toner move to the photosensitive drum 14. As described above, the transparent toner and is charged to a positive (+) polarity and the yellow toner is charged to a negative (−) polarity. Thus, the yellow toner detached from the surface of the developing roller 42 is attached to the image portion and the transparent toner is attached to the non-image portion. At this time, when at least one of the yellow toner and the transparent toner is a potato type toner, the two toners are easily separated from each other and are developed on the image portion and the non-image portion, respectively. Due to a first transfer bias voltage applied to the first transfer roller 74, the yellow toner image and the transparent toner image developed on the photosensitive drum 14 are transferred onto the intermediate transfer belt 60.

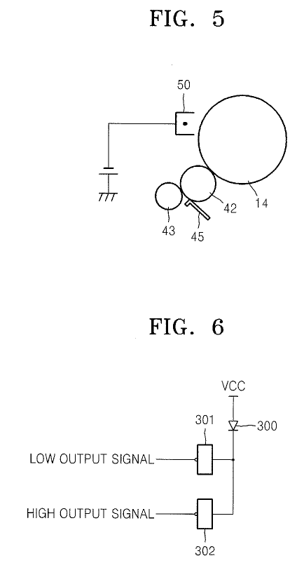

In order to improve the transfer efficiency of the yellow toner image and the transparent toner image, the charging polarities of the two toner images may be the same before the toner images are transferred onto the intermediate transfer belt 60. For example, the charging polarity of the transparent toner image may be the same as the charging polarity of the yellow toner image. Accordingly, a pre-transfer charging unit 50 is provided, as illustrated in FIG. 5. The pre-transfer charging unit 50 charges the transparent toner image to the same negative (−) polarity as the charging polarity of the yellow toner image by supplying a negative (−) charge to the transparent toner image. A first transfer bias voltage having a positive (+) polarity that is opposite to the polarities of the yellow and transparent toner images is applied to the first transfer roller 74. As such, transfer efficiency of the yellow toner image and the transparent toner image can be improved.

Through the above-described operations, the toner images of black (B), magenta (M), cyan (C), and yellow (Y), and the transparent (T) toner image are formed on the intermediate transfer belt 60. At a time in which the toner images reach a region in which the second transfer roller 75 and the intermediate transfer belt 60 face each other, the printing medium supplied from the paper feeding cassette 91 reaches the region. A second transfer bias voltage having an opposite polarity to the charging polarities of the toner images is applied to the second transfer roller 75. Then, the toner images are transferred to the printing medium. When the printing medium passes the fusing unit 92, the toner images are fixed on the printing medium by heat and pressure, and a printing operation is completed.

The toner images printed through the above-described operations are images to which the transparent toner is attached to all regions in which the yellow toner image is not attached. Thus, the gloss of a background region in which the black (B), magenta (M), cyan (C), and yellow (Y) toner images are not attached can be improved and the gloss of a region in which the black (B), magenta (M), and cyan (C) color toner images are attached can also be improved. Accordingly, in an image forming apparatus according to an embodiment of the present general inventive concept, the transparent toner image can be developed without using an additional photosensitive body, an additional exposing unit, and an additional developing unit corresponding to the transparent toner image. Thus, a low-priced and miniaturized image forming apparatus employing the transparent toner image can be implemented. In addition, a difference in gloss of the printed image between the region in which the black (B), magenta (M), cyan (C), and yellow (Y) toner images are attached and the background region can be reduced so that the quality of the printed image can be improved.

The above-described embodiments have illustrated how the exposing unit 34, which develops the transparent toner image, has performed two-level (on-off) exposure of the image portion and the non-image portion. The exposure unit 34 performing tri-level exposure will now be described.

Tri-level exposure is a technique in which the electric potential of the photosensitive drum is divided into three parts. For example, exposure output of the exposing unit 34 may be regulated as a three-level exposure, such as a high output, a low output, and off. FIG. 6 illustrates an example of a very simple control circuit which performs tri-level exposure. A laser diode 300 can be controlled with high output and low output using two laser drivers 301 and 302 that operate in response to a high-output exposure signal and a low-output exposure signal, respectively. When signals of the two laser drivers 301 and 302 are turned off, the laser diode 300 is also turned off. The tri-level exposure technique is well-known to the art and thus, a further detailed description thereof will be omitted. Novelty of the present general inventive concept includes developing of a transparent toner image using a developing unit corresponding to a color toner. Thus, the scope of the present general inventive concept is not limited by the structure of an exposing unit to perform tri-level exposure.

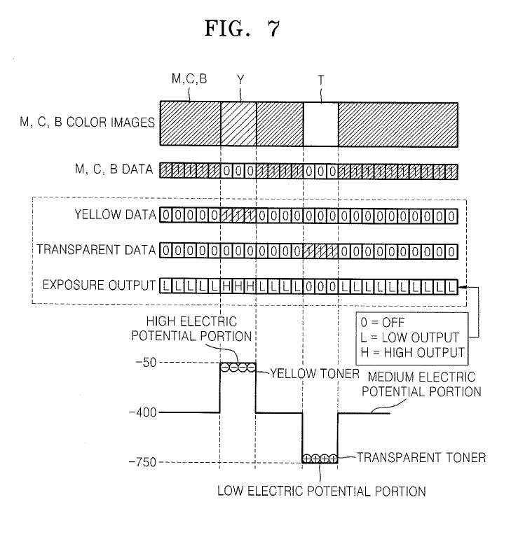

By tri-level exposure, a high electric potential portion, a medium electric potential portion, and a low electric potential portion are formed on the surface of the photosensitive drum 14, as illustrated in FIG. 7. When the photosensitive drum 14 is charged to a negative (−) polarity, the high electric potential portion is a portion exposed by high-output light, the medium electric potential portion is a portion exposed by low-output light, and the low electric potential portion is an unexposed portion. Referring to FIG. 7, when yellow data has a value of “1,” the exposure output of the exposing unit 34 is controlled with high output H, and when black (B), magenta (M), and cyan (C) data have values of “1,” the exposure output of the exposing unit 34 is controlled with low output L. When black (B), magenta (M), cyan (C), and yellow (Y) data have values of “0,” transparent data has a value of “1,” and the exposing unit 34 is turned off.

Since the average voltage of the developing bias voltage is between a voltage of the high electric potential portion and a voltage of the low electric potential portion, for example, −400 V, a yellow toner charged to a negative (−) polarity is attached to the high electric potential portion and a transparent toner charged to a positive (+) polarity is attached to the low electric potential portion. The yellow toner and the transparent toner are not attached to the medium electric potential portion. Thus, the transparent toner is attached only to a background region in which black (B), magenta (M), cyan (C), and yellow (Y) toners are not attached. Accordingly, the transparent toner is developed in the background region so that a difference in gloss between the region in which the black (B), magenta (M), cyan (C), and yellow (Y) toners are attached and the background region of the printed image can be reduced and the quality of the printed image can be improved.

In addition, in order to reduce a difference in gloss between a portion in which a high-concentration image is printed and a portion in which a low-concentration image is printed, the area of the medium electric potential portion can be controlled. That is, in spite of a portion in which the black (B), magenta (M), and cyan (C) toners are developed, when the amount of the developed toners is small, the gloss of the portion is lowered. In order to attach the transparent toner to the region, the exposing unit 34 may be turned off so that the low electric potential portion (not the medium electric potential portion) can be formed.

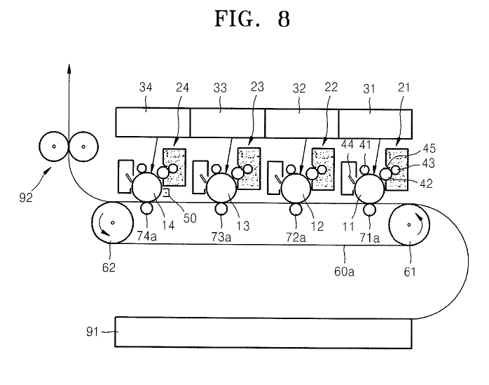

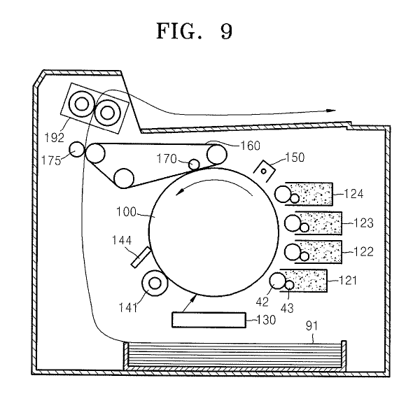

The above-described technique of developing the transparent toner may also be applied to a single pass image forming apparatus which employs a direct transfer technique in which the toner image is directly transferred to the printing medium without an intermediate transfer operation, as illustrated in FIG. 8. Referring to FIG. 8, the printing medium withdrawn from the paper feeding cassette 91 is carried by a carrying belt 60a. Each of a plurality of transfer rollers 71a, 72a, 73a, and 74a faces each of the photosensitive drums 11, 12, 13, and 14, respectively, in a state where the printing medium and the carrying belt 60a are placed therebetween. The transparent toner image and the color toner images respectively developed on the photosensitive drums 11, 12,13, and 14 are directly transferred to the printing medium by a transfer bias voltage applied to each of the transfer rollers 71a, 72a, 73a, and 74a.

The above-described technique of developing the transparent toner may also be applied to a multiple pass image forming apparatus. FIG. 9 illustrates an electrophotographic image forming apparatus according to another embodiment of the present general inventive concept. The electrophotographic image forming apparatus according to the present embodiment is a multiple pass image forming apparatus including a photosensitive drum 100, an exposing unit 130, and four developing units 121, 122, 123, and 124. Referring to FIG. 9, the four developing units 121, 122, 123, and 124 are disposed around the photosensitive drum 100. Color toners such as black (B), magenta (M), cyan (C), and yellow (Y) are accommodated in the four developing units 121, 122, 123, and 124, respectively. Furthermore, a transparent toner is accommodated in the developing unit 124 together with the yellow toner. The transparent toner is charged to an opposite polarity to the polarity of the yellow toner. At least one of the yellow toner and the transparent toner is a potato type toner manufactured by polymerization. The image forming apparatus according to the present embodiment uses a non-contact developing technique in which a developing roller 42 is separated from the photosensitive drum 100 by a developing gap. A contact developing technique in which the developing roller 42 is in contact with the photosensitive drum 100 may also be employed. Accordingly, each of the four developing units 121, 122, 123, and 124 needs to be sequentially in contact with and/or separated from the photosensitive drum 100. Even when the non-contact developing technique is employed, each of the four developing units 121, 122, 123, and 124 may sequentially face the photosensitive drum 100. As an example, the four developing units 121, 122, 123, and 124 can be installed at a rotated turret (not illustrated), and as the turret is rotated, each of the four developing units 121, 122, 123, and 124 sequentially faces the photosensitive drum 100 so that a developing operation can be performed. In addition, the four developing units 121, 122, 123, and 124 may be moved by using an actuator (not illustrated) and may also sequentially face the photosensitive drum 100. Since the present general inventive concept is characterized in that the transparent toner is developed using a developing unit corresponding to a color toner, the scope of the present general inventive concept is not limited by the above-mentioned developing techniques.

The exposing unit 130 scans light onto the photosensitive drum 100 charged by a charging roller 141 to a uniform electric potential according to black (B) image information, for example, and thereby forms an electrostatic latent image corresponding to black (B) on the surface of the photosensitive drum 100. When the black (B) toner is supplied to the electrostatic latent image by the developing unit 121, a black toner image is formed on a surface of the photosensitive drum 100. The black toner image is transferred onto an intermediate transfer belt 160 by the first bias voltage applied to a first transfer roller 170. A cleaning blade 144 eliminates the black toner that remains on the photosensitive drum 100. When the black toner image which corresponds to a sheet of paper is transferred onto the intermediate transfer belt 160, toner images of magenta (M) and cyan (C) colors are sequentially transferred onto the intermediate transfer belt 160 through the same operation.

Subsequently, the exposing unit 130 scans light onto the photosensitive drum 100 charged by a charging roller 141 to a uniform electric potential according to yellow (Y) image information, for example, and thereby forms an electrostatic latent image corresponding to yellow (Y) on the surface of the photosensitive drum 100. The yellow toner is attached to the image portion of the electrostatic latent image and the transparent toner is attached to the non-image portion. A pre-transfer charging unit 150 changes the charging polarity of the transparent toner image into the same charging polarity of the yellow toner image. The yellow toner image and the transparent toner image are transferred onto the intermediate transfer belt 160 by the first transfer bias voltage applied to the first transfer roller 170. As such, color toner images are formed on the intermediate transfer belt 160. The color toner images are transferred to the printing medium using a second transfer roller 175 and are fused on a fusing unit 192 so that color images having improved gloss can be printed.

The exposing unit 130 may be a tri-level exposing unit. Accordingly, when electrostatic latent images of black (B), magenta (M), and cyan (C) colors are formed, two-level exposure is performed, and only when an electrostatic latent image of yellow (Y) color is formed, tri-level exposure is performed.

Accommodation of the yellow toner and the transparent toner in the same developing unit 24 or 124 has been described in the above-described embodiments. However, the scope of the present general inventive concept is not limited to the above-descriptions. The transparent toner may also be accommodated together with black (B), magenta (M) or cyan (C) color toner. In addition, the scope of the present general inventive concept is not limited by the above-described developing sequence of black (B), magenta (M), cyan (C), and yellow (Y) toners. Moreover, only an image forming apparatus employing a plurality of developing units has been described in the above-described embodiments. However, the scope of the present general inventive concept is also not limited to the above descriptions. The present general inventive concept may also be applied to a single color image forming apparatus employing one developing unit to develop a single color image. Accordingly, the transparent toner may be accommodated in the developing unit together with a single color toner. In addition, use of a mono-component toner has been described in the above-described embodiments. However, the scope of the present general inventive concept is further not limited to the above-descriptions. The present general inventive concept may also be applied when a two-component developing agent in which a carrier and a toner are mixed. Accordingly, a magnetic brush comprised of a carrier and a toner may be formed on the surface of a developing sleeve in which a magnet is installed, and the toner image may be developed on the photosensitive body from the magnetic brush. A structure of a two-component developing device is well-known to the art and thus, a detailed description thereof will be omitted.

As described above, in the electrophotographic image forming apparatus according to an embodiment of the present general inventive concept, a transparent toner image can be developed using an exposing unit, a photosensitive body, and a developing unit, which are used to develop color toner images, and the transparent toner image and color toner images can be easily separated from each other and a good developing property can be achieved. Thus, a simple and low-priced electrophotographic image forming apparatus which improves gloss of a printed image can be implemented. In addition, an area of a medium electric potential portion of tri-level exposure is controlled such that gloss of the printed image is made uniform.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrophotographic image forming apparatus comprising:
a photosensitive body;
an exposing unit to form an electrostatic latent image on the photosensitive body charged to a uniform electric potential; and
a developing unit to develop the electrostatic latent image on the photosensitive body,
wherein a color toner attached to an image portion of the electrostatic latent image and a transparent toner charged to an opposite polarity to the polarity of the color toner and attached to a non-image portion of the electrostatic latent image are together accommodated in the developing unit, and
at least one of the color toner and the transparent toner is a potato type polymerization toner.

2. The apparatus of claim 1, further comprising:
a pre-transfer charging unit to charge the color toner and the transparent toner developed on the photosensitive body to the same polarity.

3. The apparatus of claim 2, further comprising:
a plurality of second photosensitive bodies;
a plurality of second exposing units to form electrostatic latent images on the plurality of the second photosensitive bodies; and
a plurality of developing units to develop electrostatic latent images on the plurality of the second photosensitive bodies and in which different color toners from the color toner are respectively accommodated,
wherein color images are formed using a single pass technique.

4. The apparatus of claim 3, wherein the exposing unit is a tri-level
exposing unit having a three-level exposure output such as a high output, a low output, and no output.

5. The apparatus of claim 2, further comprising:
a plurality of second developing units in which different color toners from the color toner are respectively accommodated; and
a transfer medium to which a transparent toner image and a plurality of color toner images sequentially developed on the photosensitive body are sequentially transferred,
wherein color images are formed using a multiple pass technique.

6. The apparatus of claim 5, wherein the exposing unit is a tri-level
exposing unit having a three-level exposure output such as a high output, a low output, and no output.

7. An electrophotographic image forming apparatus, comprising:
a photosensitive body;
an exposing unit to form an electrostatic latent image on the photosensitive body; and
a developing unit to uniformly distribute a charge on a surface of a color toner with a first polarity and to uniformly distribute a charge on a surface of a transparent toner with a second polarity opposite to that of the first polarity in order to develop the electrostatic latent image on the photosensitive body.

8. The electrophotographic image forming apparatus of claim 7, wherein the color toner is charged to be attached to an image portion of the electrostatic latent image and the transparent toner is charged to be attached to a non-image portion of the electrostatic latent image.

9. The electrophotographic image forming apparatus of claim 7, wherein at least one of the color toner and the transparent toner is a potato type toner manufactured by polymerization.

10. The electrophotographic image forming apparatus of claim 7, further comprising:
an intermediate transfer belt to which images corresponding to the color toner and the transparent toner are temporarily transferred.

11. A single pass image forming apparatus, comprising:
a plurality of photosensitive bodies to develop images thereon using a color toner with a polarized charge and a transparent toner with another polarized charge opposite to the polarized charge of the color toner; and
a plurality of transfer units corresponding to the photosensitive bodies to transfer a transparent toner image and a color toner image to a printing medium,
wherein at least one of the color toner and the transparent toner includes a surface with a uniformly distributed charge.

12. The single pass image forming apparatus of claim 11, wherein at least one of the color toner and the transparent toner is a potato type toner manufactured by polymerization.

13. The single pass image forming apparatus of claim 11, wherein different colors corresponding to the color toner image and the transparent toner image are transferred directly to the printing medium when the printing medium passes through an area between each of the plurality of photosensitive bodies and the plurality of transfer units.
